(19) United States
(12) Patent Application Publication
(10) Pub. No.: US 2013/0124355 A1
(43) Pub. Date: May 16, 2013

(54) METHOD AND SYSTEM FOR PROCESSING GROUP ORDERS

(71) Applicant: Mahmud Wazihullah, Carle Place, NY (US)

(72) Inventor: Mahmud Wazihullah, Carle Place, NY (US)

(21) Appl. No.: 13/666,486

(22) Filed: Nov. 1, 2012

Related U.S. Application Data
(60) Provisional application No. 61/557,583, filed on Nov. 9, 2011.

(51) Int. Cl. G06Q 30/06

(52) U.S. Cl. CPC G06Q 30/0605
USPC 705/26.2

(57) ABSTRACT

A system and method for group ordering is provided including displaying an item of a vendor to users of a group, receiving orders for at least one particular item associated with the same vendor from the users of the group, combining the orders into a group order, sending the group order to the single vendor, and calculating a second price for each particular item, different from the first price, based on an amount of orders received for the single vendor. Each vendor may include multiple items and each of the multiple items may include a first price. Each order may be associated with a single vendor.

### PRIORITY

The present application claims the benefit of and priority to U.S. Provisional Application Ser. No. 61/557,583 filed on Nov. 9, 2011, the entire contents of which being incorporated by reference herein.

### TECHNICAL FIELD

The present disclosure relates to a method and system for processing group orders. In particular, the present disclosure relates to a method and system for reducing the prices of items based on the number of orders received by multiple users of a group for items belonging to a single vendor.

### BACKGROUND

In the recent years, online systems have been developed for placing food orders with local restaurants. The systems available today allow one user to place a single order with a vendor for delivery. If a second user places a second order with the same vendor, and desires that the order be delivered to the same location, there is no way of ensuring that the delivery will be combined. In other words, the two orders would be delivered by two separate deliveries.

The conventional method is an inefficient means of delivering multiple orders from the same vendor to a single location in that it wastes delivery resources. Moreover, many restaurants have minimum delivery requirements. If the minimum delivery requirement is not met, then the restaurant may refuse to deliver to items until the requirement is met, or may include an additional fee for making the delivery as a penalty for not meeting the requirement.

Accordingly, a need exists for a more efficient means for processing delivery orders for food by multiple users within a group that wish to order from the same vendor, i.e. restaurant, and a means for incentivizing users to order from the same vendor.

### SUMMARY

The present disclosure is directed to a method and system for group ordering.

A method for group ordering, according to a preferred embodiment of the present disclosure, includes displaying at least one item of at least one vendor to at least one user of a group, receiving a plurality of orders for at least one particular item of the multiple items from the users of the group, wherein each order is associated with a single vendor, combining the plurality of orders into a group order, sending the group order to the single vendor, and calculating a second price for the particular item, different from the first price, based on an amount of orders received for the single vendor. Each vendor may include multiple items and each of the multiple items may include a first price.

The method may further include the step of notifying each user of the second price calculated. Additionally, or alternatively, the method may further include the step of receiving payment from the users based on the second price calculated. Additionally, or alternatively, the method may further include the step of receiving funds from each user and storing the funds in a prepaid account and the step of deducting the second price from the prepaid account. Additionally, or alternatively, the method may further include the step of notifying a second group of user, different from the users who have already placed an order, of the second price calculated. Additionally, or alternatively, the method may further include the step of receiving additional orders from at least one user of the second group and the step of calculating a third price, different from the second price, based on the amount of additional orders received. Additionally, or alternatively, the method may further include the step of adding reward points to a user account based on the second price calculated which may be used by the user to make a future payment for a future item.

A system for group ordering is also provided. The system includes a display unit configured to display at least one item of at least one vendor to at least one user of a group, wherein each vendor includes multiple items and each of the multiple items has a first price, a receiving unit configured to receive a plurality of orders for at least one particular item of the multiple items from the users of the group, wherein each order is associated with a single vendor, a combination unit configured to combine the plurality of orders into a group order, a sending unit configured to send the group order to the single vendor, and a new price calculation unit configured to calculate a second price for the particular item, different from the first price, based on the amount of orders received for the single vendor.

The system may further include a notification unit configured to notify each user of the second price calculated. Additionally, or alternatively, the receiving unit may be further configured to receive payment from the users based on the second price calculated. Additionally, or alternatively, the receiving unit may be further configured to receive funds from each user, and the system may further include a storage unit configured to store the funds received in a prepaid account and a deducting unit configured to deduct the second price from the prepaid account. Additionally, or alternatively, the system may further include a notification unit configured to notify a second group of users, different from the group of users that have already placed orders, of the second price calculated by the calculation unit. Additionally, or alternatively, the receiving unit may be further configured to receive additional orders from at least one user of the second group, and the calculation unit may be further configured to calculate a third price, different from the second price, based on the amount of additional orders received. Additionally, or alternatively, the system may further include a reward points unit configured to add reward points to a user account based on the second price calculated. The reward points may be used by the corresponding user to make a future payment for a future item.

Also provided is a non-transitory computer-readable storage medium storing a program for causing a computer to execute a method for group ordering including the steps of displaying at least one item of at least one vendor to at least one user of a group, receiving a plurality of orders for at least one particular item of the multiple items from the users of the group, wherein each order is associated with a single vendor, combining the plurality of orders into a group order, sending the group order to the single vendor, and calculating a second price for the particular item, different from the first price, based on an amount of orders received for the single vendor. Each vendor may include multiple items and each of the multiple items may include a first price.

The program may further cause the computer to perform the step of notifying each user of the second price calculated. Additionally, or alternatively, the program may further cause the computer to perform the step of receiving payment from the users based on the second price calculated. Additionally, or alternatively, the program may further cause the computer to perform the step of receiving funds from each user and storing the funds in a prepaid account and the step of deducting the second price from the prepaid account. Additionally, or alternatively, the program may further cause the computer to perform the step of notifying a second group of user, different from the users who have already placed an order, of the second price calculated. Additionally, or alternatively, the program may further cause the computer to perform the step of receiving additional orders from at least one user of the second group and the step of calculating a third price, different from the second price, based on the amount of additional orders received. Additionally, or alternatively, the program may further cause the computer to perform the step of adding reward points to a user account based on the second price calculated which may be used by the user to make a future payment for a future item.

Also provided is a system for group ordering including a means for displaying at least one item of at least one vendor to at least one user of a group, wherein each vendor includes multiple items and each of the multiple items has a first price, a means for receiving a plurality of orders for at least one particular item of the multiple items from the users of the group, wherein each order is associated with a single vendor, a means for combining the plurality of orders into a group order, a means for sending the group order to the single vendor, and a means for calculating a second price for the particular item, different from the first price, based on an amount of orders received for the single vendor.

### BRIEF DESCRIPTION OF THE DRAWINGS

Various embodiments of the present disclosure will be described below with reference to the figures, wherein:

FIG. 1 is a view showing an example system for group ordering according to an embodiment of the present disclosure;

FIG. 2 is a block diagram showing the components of the system illustrated in FIG. 1;

FIG. 3 is a flow chart of a method for group ordering in accordance with an embodiment of the present disclosure;

FIG. 4 is a flow chart of a method for group ordering according to an embodiment of the present disclosure;

FIG. 5 is a flow chart of a method for group ordering according to an embodiment of the present disclosure;

FIG. 6 is a flow chart of a method for group ordering according to an embodiment of the present disclosure;

FIG. 7 is a drawing of an exemplary user interface illustrating multiple venders that users may select from according to an embodiment of the present disclosure;

FIG. 8 is a drawing of an exemplary user interface illustrating multiple items that are available and offered by the vendor selected from FIG. 7 according to an embodiment of the present disclosure;

FIG. 9 is a drawing of an exemplary user interface illustrating an order placed by a user of a group before any other users place an order with the same vendor, showing a first price for an item, according to an embodiment of the present disclosure; and

FIG. 10 is a drawing of an exemplary user interface illustrating a second order placed by a second user of the same group as in FIG. 9, placed with the same vendor, in accordance with an embodiment of the present disclosure.

### DETAILED DESCRIPTION

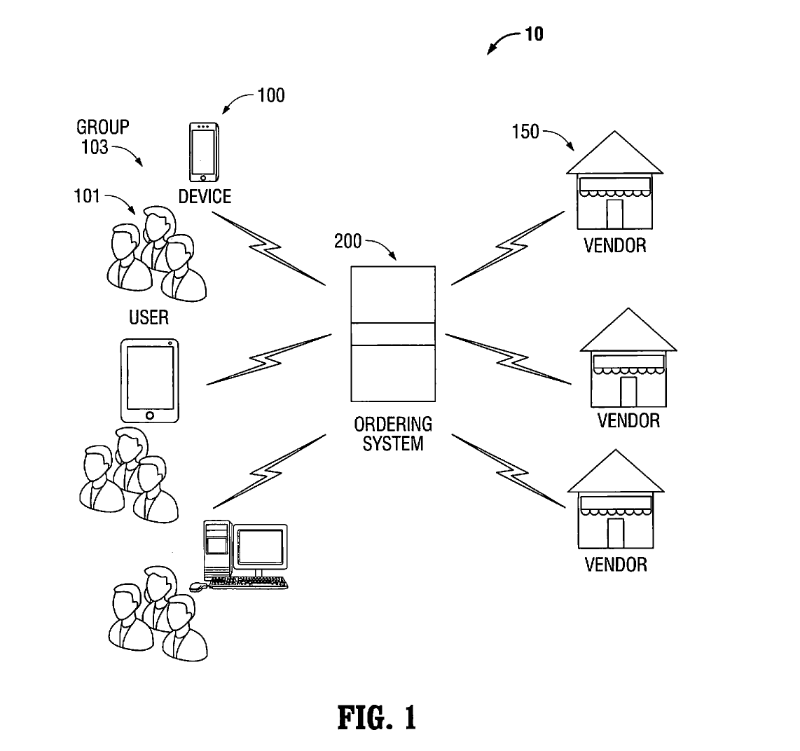

FIG. 1 illustrates an example system 10 for group ordering according to certain embodiments of the present disclosure. System 10 includes devices 110 which communicate through ordering system 200 to vendors 150. Users 101 may be associated with each other within a group 103. Each user 101 may control a device 110 for placing an order through ordering system 200 to different vendors 150. Although this particular implementation of system 10 for group ordering is illustrated and primarily described, the present disclosure contemplates any suitable network implementation of system 10 for group ordering, or any of its components, according to particular needs of the institution or facility.

Continuing with reference to FIG. 1, users 101 may be individuals that wish to place an order with vendors 150, such as a food order. Users 101 may be associated with a particular group 103. Group association of the users 101 may depend on the physical location of the users 101, where the users 101 register, where the users 101 would like the food to be delivered, or any other such association as would be understood in the art, for example and without limitation, houses or residences in a neighborhood, schools, churches, places of business, etc. In one embodiment, users 101 are associated with a particular group 103 based on the office or delivery location which the users 101 commonly deliver food, such as and without limitation, places where the users 101 work or live. However, it is envisioned that users 101 may be associated with a particular group 103 by other means as well.

Continuing with reference to FIG. 1, users 101 may place orders through ordering system 200 via device 110. Device 110 may be any device that is capable of receiving input data from users and transmitting the data to ordering system 200. For example and without limitation, device 110 may be a desktop computer, laptop computer, tablet device, mobile device such as a cellular phone, or any other device suitable for, and capable of, receiving orders from users 101 and transmitting the orders to vendors 150.

Vendors 150 may include any restaurants, catering services, food delivery services, food cart, or other food entity that offers food products for sale. Additionally, or alternatively, vendors 150 may include any individual or company that offers any type of goods or services for sale. Each vendor 150 may offer a variety of items for sale or delivery, or a single item for sale or delivery.

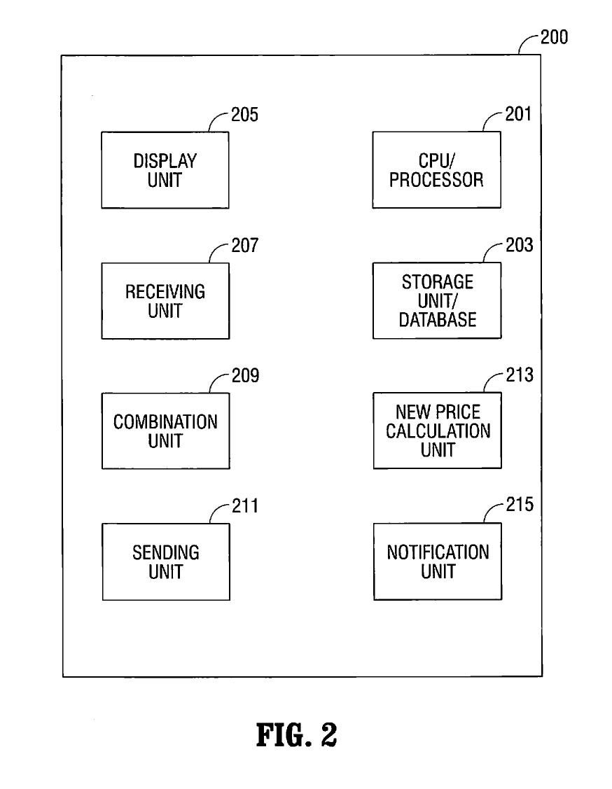

Turning now to FIG. 2, and continuing with reference to FIG. 1, ordering system 200 of system 10 for group ordering, will now be discussed with particular detail. Ordering system 200 may include a central processing unit 201, a storage unit or database 203, a display unit 205, a receiving unit 207, a combination unit 209, a sending unit 211, a new price calculation unit 213, and a notification unit 215. It is understood, that although particular units of ordering system 200 described below are described as being configured to perform particular tasks or functions, any of the units of ordering system 200 may be capable of performing any of the tasks of any of the other units of ordering system 200. The term “unit,” as used herein, may include modules, software and/or hardware, digital or analog, that cooperate to perform one or more control tasks and may include digital commands, power circuitry, networking hardware, an/or a set of programmable instructions for implementation and execution by at least one processor, or central processing unit 201, to carry out any of the steps described herein.

Continuing with reference to FIG. 2, the processor 201 of ordering system 200 is configured to process any of the steps or functions of ordering system 200 and/or any of the modules or units therein. The term processor, as used herein, may be any type of controller or processor, and may be embodied as one or more controllers or processors adapted to perform the functionality discussed herein. Additionally, as the term processor is used herein, a processor may include use of a single integrated circuit (IC), or may include use of a plurality of integrated circuits or other components connected, arranged or grouped together, such as controllers, microprocessors, digital signal processors, parallel processors, multiple core processors, custom ICs, application specific integrated circuits, field programmable gate arrays, adaptive computing ICs, associated memory, such as and without limitation, RAM, DRAM and ROM, and other ICs and components.

Continuing with reference to FIG. 2, the database 203 of ordering system 200 may be configured to store information pertinent to users 101, groups 103, ordering delivery destinations, vendors 150, payment information, history of transactions, and any other such data as may be deemed necessary for implementation of the methods described herein. Additionally, or alternatively, database 203 of ordering system 200 may store funds in a prepaid account associated with each user 101 or a group 103 of users 101. Additionally, or alternatively, database 203 of ordering system 200 may be tied to a third-party payment system, such as an without limitation, PayPal®.

As used herein, the term database or storage unit may be understood to include, and is not limited to, repository, databank, database, cache, storage unit, cloud, and the like, a data repository, any computer or other machine-readable data storage medium, memory device or other storage or communication device for storage or communication of information, currently known or which becomes available in the future, including, but not limited to, a memory integrated circuit, or memory portion of an integrated circuit (such as the resident memory within a processor), whether volatile or non-volatile, whether removable or non-removable, including without limitation RAM, FLASH, DRAM, SDRAM, SRAM, MRAM, FeRAM, ROM, EPROM or E2PROM, or any other form of memory device, such as a magnetic hard drive, an optical drive, a magnetic disk or tape drive, a hard disk drive, other machine-readable storage or memory media such as a floppy disk, a CDROM, a CD-RW, digital versatile disk (DVD) or other optical memory, or any other type of memory, storage medium, or data storage apparatus or circuit, which is known or which becomes known, depending upon the selected embodiment.

Additionally, or alternatively, such computer readable media includes any form of communication media which embodies computer readable instructions, data structures, program modules or other data in a data signal or modulated signal, such as an electromagnetic or optical carrier wave or other transport mechanism, including any information delivery media, which may encode data or other information in a signal, wired or wirelessly, including electromagnetic, optical, acoustic, RF or infrared signals, and so on. The memory may be adapted to store various look up tables, parameters, coefficients, other information and data, programs or instructions (of the software of the present disclosure), and other types of tables such as database tables.

Continuing with reference to FIG. 2, the display unit 205 of ordering system 200 may be configured to display items offered for sale from vendors 150. In particular, the display unit 205 may display items, such as food items, which are offered for sale or delivery by vendors 150, as will be described in further detail below. Additionally, or alternatively, the display unit 205 may display the prices associated with each of the items displayed and other user 101 and group 103 information as may be desired.

Continuing with reference to FIG. 2, the receiving unit 207 of ordering system 200 may be configured to receive a single order, or plurality of orders, for at least one particular item from the users 101 of a group 103, as will be described in further detail below. In particular, the receiving unit 207 may receive information or data, such as and without limitation, data associated with the food items desired by a particular user 101 to be delivered and where to deliver the item to. Additionally, or alternatively, the receiving unit 207 may be further configured to receive payment from the users 101, or the group 103, based on the items ordered through ordering system 200. The payment may be received by the user 101 or the group 103 via ACH from a linked bank account, credit card payment, debit card payment, money transfer, deduction from accounts stored in the storage unit 203, or any other means recognized or appreciated in the art for making payments or transferring funds. The receiving unit 207 may be associated with a deducting unit for deducting the funds from a user 101 or group 103 prepaid account that is stored in the database 203.

Continuing with reference to FIG. 2, the combination unit 209 of ordering system 200 may be configured to combine the orders received by the receiving unit 207, as will be described in further detail below. In particular, the combination unit 209 may be configured to associate each of the users 101 with corresponding groups 103. Additionally, or alternatively, the combination unit 209 may search through the orders that were received by the receiving unit 207 and determine which orders were received for the same vendor 150. Additionally, or alternatively, the combination unit 209 may combine the orders for the single vendor 150 into a single order.

Continuing with reference to FIG. 2, the sending unit 211 may be configured to send the group order which was combined by the combination unit to the single vendor 150, as will be described in further detail below. In particular, the sending unit 211 may send each vendor 150 only a single order which includes each of the individual orders that were received by the receiving unit 207 and combined by the combination unit 209.

Continuing with reference to FIG. 2, the new price calculation unit 213 may be configured to calculate a new price, also described herein as a second price and/or third price, for items offered for sale or delivery by vendors 150, as will be described in further detail below. The new or second price is different form the original price displayed by the display unit 205 and is based on the amount of orders received by a particular group 103 of users 101 and/or the total value of the orders. Generally, the more orders received through receiving unit 207 by a particular group 103 of users 101 with a single vendor 150, the lower the second, third, or new price calculated by calculation unit 213 will be. Alternatively, it is also envisioned that certain embodiments may increase the price of items based on the higher number of orders received, especially in situations where the items offered for sale are items that are high in demand.

Continuing with reference to FIG. 2, ordering system 200 may further include a notification unit 215 which may be configured to notify each user 101 of the second, third, or otherwise new, price calculated, as will be described in further detail below. Additionally, or alternatively, the notification unit 215 may be configured to notify different users 101 from the group 103 of users 101 that already placed orders of the second, or otherwise new, price that has been calculated by the calculation unit 213.

Ordering system 200 may further include a reward points unit (not shown) which may be configured to add reward points to a user's 101 or group's 103 account based on the amount of items ordered, cost of the order, frequency of the order, or any other such dependencies that may be appreciated in the art. The rewards accumulated may be used for future purchases of items, donations, or any other such uses as may be appreciated in the art.

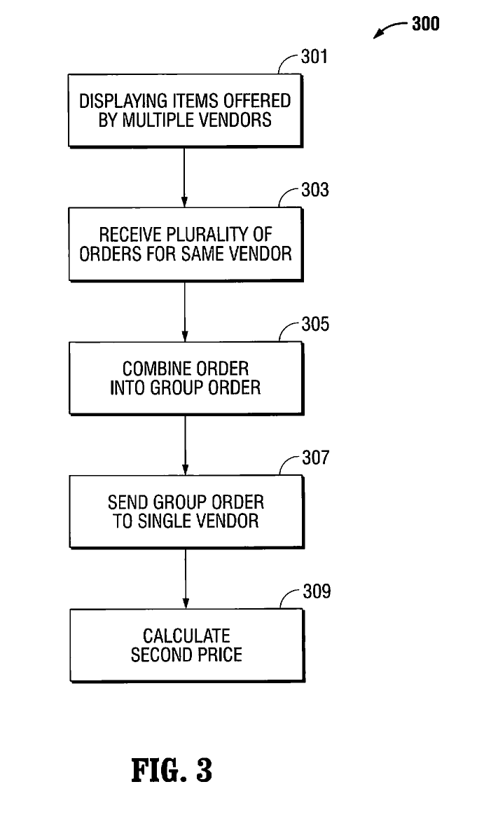

Turning now to FIG. 3, a method for group ordering 300 is shown and will be described with particular detail below. Although shown in the figures and described herein as including particular steps, it is appreciated that some of the steps of method 300 may not be required. Additionally, or alternatively, it is also appreciated that although described in a particular order, method 300 may be accomplished in any order not particularly described herein.

Method for group ordering 300 begins with step 301 by displaying at least one item of at least one vendor 150 to at least one user 101 of a group 103. Each vendor 150 may include multiple items and each of the multiple items has a first price. The items may be displayed on a device 110 associated with a particular user 101 or group 103.

Continuing with reference to FIG. 3, subsequent to displaying the items of the vendors 150 to at least one user 101 in step 301, the method for group ordering 300 proceeds to step 303 where ordering system 200 receives a plurality of orders for at least one particular item of the multiple items displayed in step 301. In other words, users 101 of a group 103 may place an order for items displayed in step 301. The plurality of orders may be received in one order by the group 103, or may be received in multiple separate orders by each user 10 individually.

Continuing with reference to FIG. 3, subsequent to receiving a plurality of orders for at least one particular item of the multiple items displayed from the users 101 of a group 103 in step 303, the method for group ordering 300 proceeds to step 305 where the ordering system 200 combines the plurality of orders into a single group order. In particular, in step 305, the ordering system 200 determines which users 101 may be associated with the same group 103, and may further determine which users 101 of the same group 103 have ordered items from the same vendor 150. In other words, ordering system 200 may determine, of the orders received in step 303, which ones are associated with the same vendors 150.

Continuing with reference to FIG. 3, subsequent to combining the group orders into a single order in step 305, method for group ordering 300 then proceeds to step 307 where ordering system 200 sends the group order to the single vendor 150. The group order sent in step 307 may be sent to the vendor via facsimile, telephone, e-mail, instant notification, or any other delivery means known in the art. It is envisioned that in one embodiment, each vendor 150 may have a device which is similar to device 110 used by the users 101, for receiving the orders.

Continuing with reference to FIG. 3, subsequent to sending the group order to the single vendor 150 in step 307, method 400 then proceeds to step 309 where ordering system 200 calculates a second price for the item. The second price may be different from the first price. The difference between the second price and the first price may be based on, or otherwise dependent from, the amount of orders that were placed by a particular user 101 or group 103 of users 101, and/or the value of the orders. For example and without limitation, if a user 101 of a group 103 selects a particular item having a first price, ordering system 200 may calculate a second price for that particular item, and/or all items offered by that particular vendor 150, and offer that second price to the remaining users 101 within that group 103. Additionally, upon receiving additional orders from the other users 101 a third price may be calculated, as will be described in further detail below.

Although described herein as a second price, third price, etc., it is also envisioned that these increments in price may also be percentage discounts to be applied. For example and without limitation, instead of, or in addition to, calculating a second price based on a predetermined discount amount, i.e. five cents, to be discounted from the first price, a predetermined or tiered percentage, i.e. 5%, may be discounted from the first price to calculate the second price. This logic follows for all of the different prices calculated within, and by, ordering system 200 including the third price or any other new price.

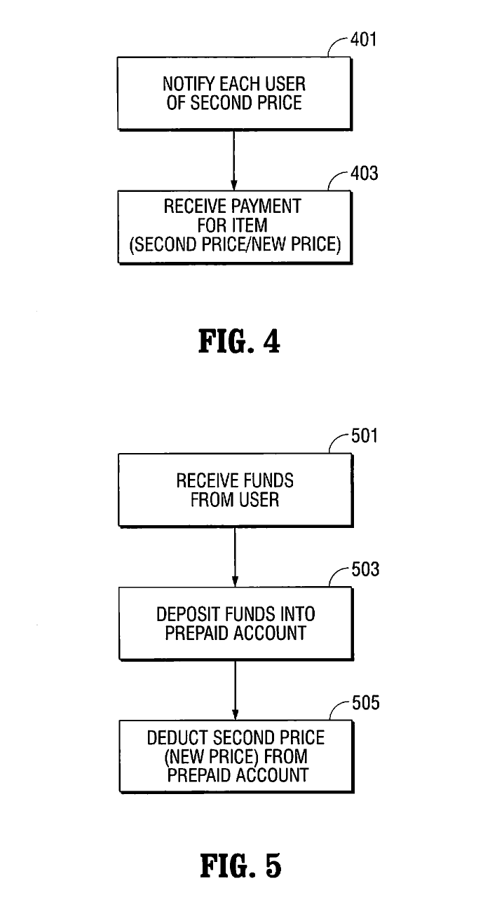

Turning now to FIG. 4, ordering system 200, and/or method 300, may proceed to step 401 where ordering system 200 may be configured to notify each user 101 or group 103 of the second price calculated in step 309. The step of notifying the users 101 or groups 103 may be accomplished by any means appreciated in the art such as and without limitation email notification, instant message notification, or the like.

Continuing with reference to FIG. 4, subsequent to calculating the second price in step 309, or additionally, subsequent to notifying each user 101 or group 103 of the second price in step 401, method 300 or ordering system 200 may proceed to step 403 where ordering system 200 receives payment for the item based on that last price calculated, i.e. the second or third price calculated.

Turning briefly to FIG. 5, a means for payment of items by users 101 or a group 103 is shown. In step 501, ordering system 200 receives funds from a user 101 or group 103. Step 501 may be accomplished by money transfer, third party transfer, ACH transfer, bank transfer, credit card payment, debit card payment, or any other means appreciated in the art for transferring funds between parties. In step 503, ordering system 200 deposits, or otherwise stores the funds received in step 501 in a user prepaid account, or a group prepaid account. The prepaid accounts may be used by the corresponding users 101 or groups 103 for making payments for items ordered. At step 503, ordering system 200 deducts the last price, which may be the first price, second price, third price, etc., from the user prepaid account or the group prepaid account. Although prepaid accounts may be used, it is appreciated that payments may be made individually for each item ordered by means other than through the prepaid accounts.

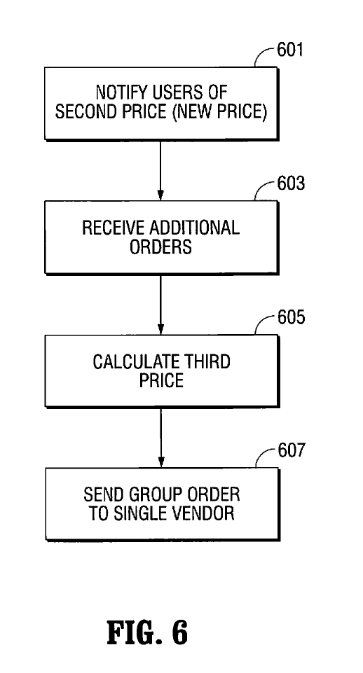

Turning now to FIG. 6, in particular embodiments method 300 may further include the step of notifying users 101 or groups 103 of the second price calculated in step 309. Subsequent to notifying users 101 or groups 103 of the second price calculated from step 309 in step 601, the method 300 may further proceed to step 603 where ordering system 200 receives additional orders from the users 101 or groups 103 that were notified in step 601. Subsequent to receiving the additional orders in step 603, method 300 may further include step 605 where ordering system 200 calculates a third price for the items. Calculation of the third price in step 605 is accomplished by similar means as the calculation of second price in step 309, and thus will not be described any further. Subsequent to completing all or some of the steps described above, in step 607 ordering system 200 sends the group order to a single vendor 150 in a similar manner as described above with respect to step 307.

In one embodiment, ordering system 200 suggests a particular vendor 150 or item offered by the vendor 150, and/or a particular group of vendors 150 that are located within the same vicinity, to a user 101 or group 103 of users 101. Additionally, or alternatively, the users 101 or group of users 103 may not know one another and/or may be located within the same vicinity, such as and without limitation and office building.

If multiple users 101 in a group 103 order from the same vendor 150, then the vendor 150 will be required to make only one delivery of the items ordered, thus saving costs for all of the parties involved in the transaction.

In another embodiment, each day each group 103 of users 101 or building may be assigned a different vendor 150 as a restaurant of the day.

It is envisioned that in any of the embodiments, or combination of embodiments, described above a reward point system may be used. In particular, users 101 or groups 103 of users 101 may be incentivized to place order with the reward of receiving reward points. The reward points may be used for any purpose appreciated in the art, such as and without limitation, future orders placed, current orders, donations, and/or cash refunds.

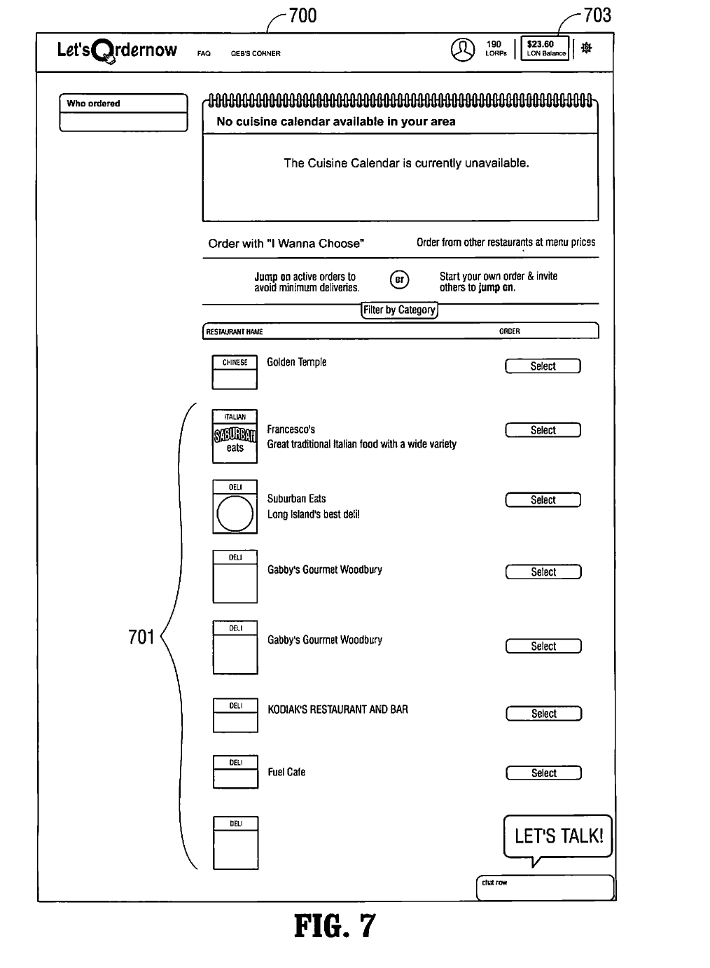

Turning now to FIGS. 7-10, drawings of exemplary user interfaces are shown that may be displayed on devices 110.

With particular reference to FIG. 7, a drawing of an exemplary user interface screen 700 is shown illustrating a variety of vendors 150, as 701, which users 101 or groups 103 may select from. User interface screen 700 may be a web page corresponding to a website maintained by one or more computing devices, such as servers. User interface screen 700, and other user interface screens described herein, may be accessible by users 101 or groups 103 via a web browser, such as and without limitation Internet Explorer®, Firefox®, Chrome®, etc., via devices 110. The variety 701 may be arranged and displayed in a particular order, for example and without limitation, by the distance from the user 101 or group 103, or may not be arranged in any particular order. Additionally shown in user interface screen 700 is the balance remaining in the user or group prepaid account, which is shown as element 703. On user interface screen 700, a user 101 may select a vendor 150 from the variety 701 displayed. A selection of a particular vendor 150 from the variety 701 causes ordering system 200 to receive a command to display user interface screen 800 as described below.

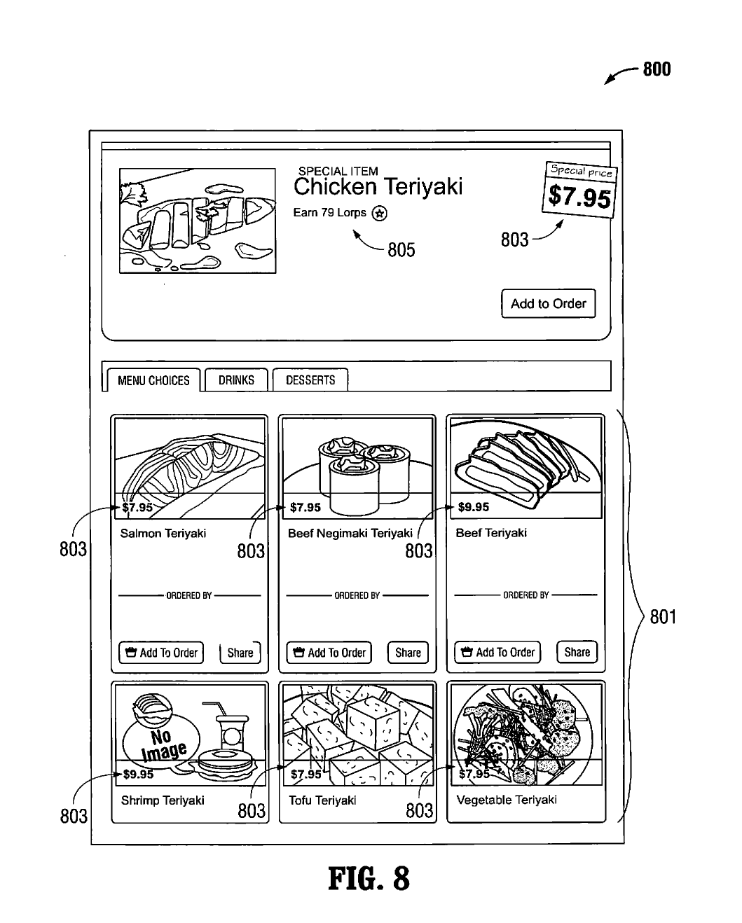

Turning now to FIG. 8, a user interface 800 is shown which includes a variety of items 801 that may be offered by the particular vendor 150 selected from the variety 701 of vendors 150 in user interface screen 700 from FIG. 7. Each item of the variety of items 801 includes a corresponding first price 803 for that item. As described above, as users 101 of a group 103 order more items from one particular vendor the price 803 that is displayed is reduced to the second price, the third price, etc. Also shown on user interface 800 is the reward points 805 that is offered should a user select a particular item. Subsequent to selecting one or more of the items of the variety of items 801 displayed on user interface 800, user interface 900 is displayed as will be described in further detail below.

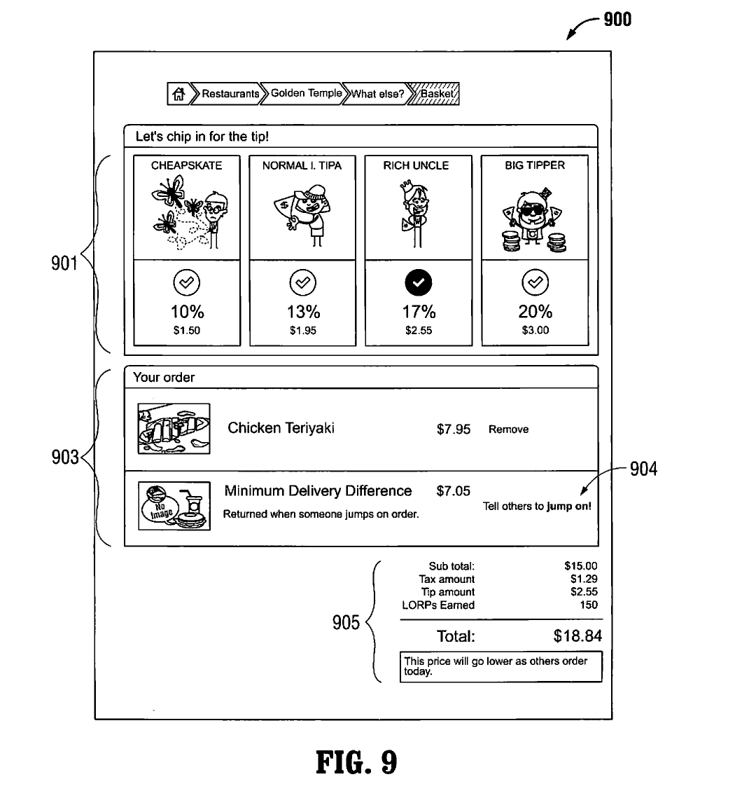

Turning now to FIG. 9, user interface 900 is shown with a gratuity section 901, summary of order section 903, and payment section 904. A user 101 may select an amount of gratuity to add by selecting one of the preset gratuities offered in the gratuities section 901. The summary of order section 903 shows a summary of the order being processed, i.e., the selection of items made in user interface screen 800. As shown in FIG. 9, because the user 101 did not meet the minimum requirement for delivery, there is an additional $7.05 charge. However, the user 101 is able to select item 904 which commands ordering system 200 activate the notification unit described above. Activation of the notification unit prompts ordering system 200 to notify other users 101, within the same group 103 as the user 101 who has placed the initial order, to also place an order with the same vendor 150. If other users 101 within the same group 103 join on the order, then a second price will be calculated for the items ordered, and the minimum delivery charge of $7.05 may be removed as being satisfied with the combined order of the group 103.

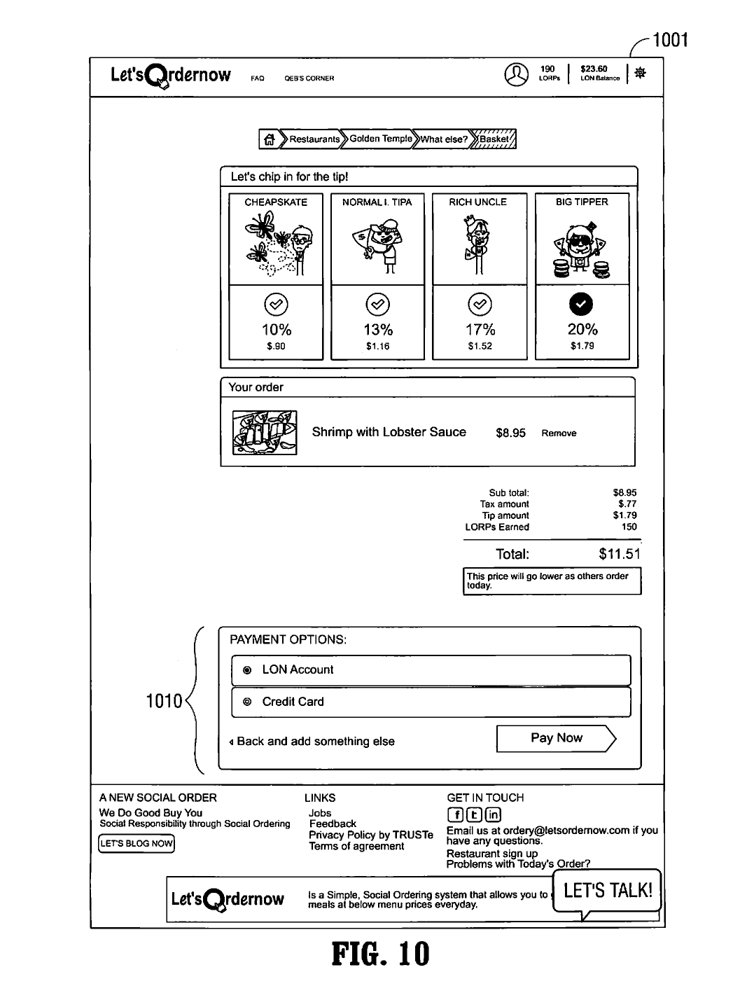

Turning now to FIG. 10, a user interface 1001 is shown for a different user 101 than the one described above with respect to FIG. 9, that belongs to the same group 103 as the user 101 described with respect to FIG. 9. As illustrated in FIG. 10, the minimum delivery charge is not present because in combination with the order from FIG. 9, the minimum delivery price has been met and is no longer required. Additionally, as shown in FIG. 10, user interface 1001 includes a payment selection method 1010 which enables the user 101 to select the payment method for completing the order.

Although, the above-described embodiments have been described as being applicable to food ordering, it is envisioned that any of the above-described embodiments may be implemented in any ordering system and may be used to place orders between any party not described above, to any party not described above, for any item. For example and without limitation, ordering system 200 may be used by and for ordering any goods not limited to food. Additionally, groups 103 are not limited to the group described herein, and may include houses or residents in a neighborhood, schools, churches, etc.

It will be appreciated that features of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims. Although specific terms are employed herein, they are used in a generic and descriptive sense only and not for purposes of limitation.

What is claimed is:

1. A method for group ordering, comprising:
displaying at least one item of at least one vendor to at least one user of a group, wherein each vendor includes multiple items and each of the multiple items has a first price;
receiving a plurality of orders for at least one particular item of the multiple items from the users of the group, wherein each order is associated with a single vendor;
combining the plurality of orders into a group order;
sending the group order to the single vendor; and
calculating a second price for the particular item, different from the first price, based on an amount of orders received for the single vendor.

2. The method according to claim 1, further comprising notifying each user of the second price calculated.

3. The method according to claim 2, further comprising receiving payment from the users based on the second price calculated.

4. The method according to claim 1, further comprising receiving funds from each user and storing the funds in a prepaid account and deducting the second price from the prepaid account.

5. The method according to claim 1, further comprising notifying a second group of users of the second price calculated.

6. The method according to claim 5, further comprising:
receiving additional orders from at least one user of the second group;
and calculating a third price different from the second price based on the amount of additional orders received.

7. The method according to claim 1, further comprising adding reward points to a user account based on the second price calculated, wherein the reward points may be used by the corresponding user to make a future payment for a future item.

8. A system for grouping orders, comprising:
a display unit configured to display at least one item of at least one vendor to at least one user of a group, wherein each vendor includes multiple items and each of the multiple items has a first price;
a receiving unit configured to receive a plurality of orders for at least one particular item of the multiple items from the users of the group, wherein each order is associated with a single vendor;
a combination unit configured to combine the plurality of orders into a group order;
a sending unit configured to send the group order to the single vendor; and
a new price calculation unit configured to calculate a second price for the particular item, different from the first price, based on the amount of orders received for the single vendor.

9. The system according to claim 8, further comprising a notification unit configured to notify each user of the second price calculated.

10. The system according to claim 9, wherein the receiving unit is further configured to receive payment from the users based on the second price calculated.

11. The system according to claim 8, wherein the receiving unit is further configured to receive funds from each user, and the system further comprises a storage unit configured to store the funds in a prepaid account and a deducting unit configured to deduct the second price from the prepaid account.

12. The system according to claim 8, further comprising notification unit configured to notify a second group of users of the second price calculated.

13. The system according to claim 12, wherein the receiving unit is further configured to receive additional orders from at least one user of the second group, and the calculation unit is further configured to calculate a third price, different from the second price, based on the amount of additional orders received.

14. The system according to claim 8, further comprising a reward points unit configured to add reward points to a user account based on the second price calculated, wherein the reward points may be used by the corresponding user to make a future payment for a future item.

15. A non-transitory computer-readable storage medium storing a program for causing a computer to execute a method for group ordering, comprising:
displaying at least one item of at least one vendor to at least one user of a group, wherein each vendor includes multiple items and each of the multiple items has a first price;
receiving a plurality of orders for at least one particular item of the multiple items from the users of the group, wherein each order is associated with a single vendor;
combining the plurality of orders into a group order;
sending the group order to the single vendor; and
calculating a second price for the particular item, different from the first price, based on an amount of orders received for the single vendor.

16. The non-transitory computer-readable storage medium according to claim 15, further comprising notifying each user of the second price calculated.

17. The non-transitory computer-readable storage medium according to claim 16, further comprising receiving payment from the users based on the second price calculated.

18. The non-transitory computer readable-storage medium according to claim 15, further comprising receiving funds from each user and storing the funds in a prepaid account and deducting the second price from the prepaid account.

19. The non-transitory computer-readable storage medium according to claim 15, further comprising notifying a second group of users of the second price calculated.

20. The non-transitory computer-readable storage medium according to claim 19, further comprising:
receiving additional orders from at least one user of the second group;
and calculating a third price different from the second price based on the amount of additional orders received.

21. A system for group ordering, comprising:
means for displaying at least one item of at least one vendor to at least one user of a group, wherein each vendor includes multiple items and each of the multiple items has a first price;
means for receiving a plurality of orders for at least one particular item of the multiple items from the users of the group, wherein each order is associated with a single vendor;
means for combining the plurality of orders into a group order;
means for sending the group order to the single vendor; and
means for calculating a second price for the particular item, different from the first price, based on an amount of orders received for the single vendor.
